(19) United States
(12) Patent Application Publication
(10) Pub. No.: US 2024/0287694 A1
(43) Pub. Date: Aug. 29, 2024

(54) DEVICE AND METHOD FOR IONIC SHUNT CURRENT ELIMINATION

(71) Applicant: H2PRO LTD, Caesarea (IL)

(72) Inventors: Idan ROM, Ramat Gan (IL); Mordechay MOSHKOVICH, Raanana (IL); Hen DOTAN, Moshav Richan (IL)

(21) Appl. No.: 18/572,590

(22) PCT Filed: Jun. 20, 2022
(86) PCT No.: PCT/IL2022/050657

§ 371 Date: Dec. 20, 2023

Related U.S. Application Data
(60) Provisional application No. 63/202,688, filed on Jun. 21, 2021.

(51) Int. Cl. C25B 15/06; C25B 1/04; C25B 9/65; C25B 9/75; C25B 9/77; C25B 15/08

(52) U.S. Cl. CPC C25B 15/06; C25B 1/04; C25B 9/65; C25B 9/75; C25B 9/77; C25B 15/087

(57) ABSTRACT

The invention provides a bipolar system comprising two or more electrochemical cells and a bipolar connector operable as a shunt current suppression device positioned in a flow path of an electrolyte solution flowing between the cells.

### TECHNOLOGICAL FIELD

The invention generally contemplates a device and a method for ionic shunt current elimination in electrochemical systems.

### BACKGROUND OF THE INVENTION

The bipolar electrochemical cells connection method is commonly used in the electrochemical industry (batteries, super capacitors, fuel cells, electrolyzers) for multi cell stacking and connections. It was developed to reduce power loss due to series resistance. This method requires the anode of one electrode set to be connected to the cathode of the next electrode set while avoiding or minimizing electrolyte connection between the electrode sets. In electrochemical thermally activated chemical cell (E-TAC) electrolyzer [1,2], the anode and cathode of a single stack (or roll) are contained within a single compartment and the electrolyte flows between neighboring stacks. Therefore, the bipolar connector (BPC) must provide an electrical ionic insulation between adjacent stacks, and at the same time must provide passage of electrolyte and produced gas through the reactor.

Two configurations of electrochemical cell stacks are known:
Monopolar cell stacking (depicted in FIG. 1)—where the cells are connected in parallel, such that the positive poles are connected together and the negative poles are separately connected. The connection may be between separate individual cells by wiring to the cell's enclosure or between electrodes connected and immersed in the same cell solution, sharing the same electrolyte environment. In such a monopolar configuration, the system current is the sum of currents and the system voltage is the same as the voltage of each of the individual cells. Accordingly, due to resistance effects, with an increase in the current, the electrode may generate heat. From a mechanical point of view, in an electrolyzer assembly, this is the simplest cell configuration, whereby all cells in a stack are immersed in the same electrolytic environment without short circuiting.
Bipolar cell stacking (depicted in FIG. 2)—in such a configuration the cell is connected in series, each positive pole is connected to the negative pole in an adjacent cell. The connection can be of separate individual cells by wiring to the cell enclosure or to electrodes connected and immersed in the same cell enclosure; however, in contrast to the monopolar configuration there must be an electrical separation of the electrolyte (ionic disconnect) between individual cells in order to avoid short circuit. The positive and negative poles of adjacent cells are usually connected by a bipolar plate which is a common current collector between the electrodes, creating a physical barrier between cells and the required electronic conduction. The system voltage is the sum of cell voltages. The system current is the current of each of the individual cells. Accordingly, heat generated due to resistance with the applied current is minimal. The challenge of such a system is, however, to overcome possible “soft short circuiting” and leakage current, especially in flow-based systems where the electrolyte flows and has a common reservoir for all cells.

### PUBLICATIONS

[1] International Patent Application No. PCT/IL2015/051120;
[2] International Patent Application No. PCT/IL2019/050314;
[3] US 2019/218678;
[4] U.S. Pat. No. 4,277,317;
[5] U.S. Pat. No. 3,666,561;
[6] U.S. Pat. No. 3,634,139;
[7] U.S. Pat. No. 3,522,098;
[8] U.S. Pat. No. 3,537,904;
[9] US 2018/342751;
[10] US 2019/252709;
[11] US 2014/060666;
[12] CN 106207240;
[13] WO 2016/128038;
[14] US 2014/272512;
[15] US 2012/308856;
[16] U.S. Pat. No. 4,377,445;
[17] WO 2007/131250;
[18] JP 62108465;
[19] JP 59127378;
[20] US 2014/287335.

### General Description

Flow based systems such as electrolyzers, fuel cells and flow batteries, use bipolar plates that are positioned between the negative and positive poles of neighboring cells. The bipolar plate serves as a common current collector while creating physical barrier between cells. The barrier avoids a “soft” short circuit due to having an ionic conductance as a source of current leakage that would be generated in case the same electrolytic environment is in direct and close contact to the neighboring electrodes. This mechanism of current leakage in a bipolar stack is depicted in FIG. 3.

Due to the potential gradient between pairs of electrodes (EP1, EP2 in FIG. 3) a leakage current (Iₗₑₐₖ) flows between an anode of one electrode set, EP1, and a cathode of another electrode set, EP2. This is a faradaic current with high overpotentials. Its value can be higher than the reaction currents, I_{react}_{₁}, I_{react}_{₂}, flowing between electrodes in the same electrode set. The leakage current, Iₗₑₐₖ, causes significant power losses during the electrolysis process. To reduce the current leakage, an ionic electrical insulation must be implemented between adjacent pairs of electrodes, while permitting electrolyte connection, which conventional bipolar plates do not due to the physical separation they create between the two cells.

In a typical electrochemical thermally activated chemical cell (E-TAC) electrolyzer, the anode and cathode of a single stack (or roll) are contained within a single compartment and the electrolyte flows between neighboring stacks. A bipolar connector (BPC) positioned in such an electrolyzer must therefore provide an electrical ionic insulation between adjacent stacks (electrolytic/electrochemical cell/cell-stack) and must also allow for passage of electrolyte and produced gas through the reactor. E-TAC systems are configured to continuously function for as long as the reactants are supplied to the cells and reaction products are removed. This maintains a substantially stable and invariant system. Because of the conductivity of the liquid electrolyte and the electrical field potential gradient, ionic shunt currents may flow between individual cells and between cell stacks by traveling through the conductive liquid electrolyte pathways. The presence of ionic shunt currents reduces electrical storage and discharge capacity of each stack and can also decrease the energy efficiency of the overall system.

In a prior art system depicted in FIG. 4, a bipolar plate (Appartus #1) forms a conductive physical barrier between the electrochemical cells for the purpose of avoiding flow of electrolyte through it and preventing ionic conductivity between the cells, while permitting electric conductivity between the anode and cathode of neighboring electrochemical cells. A shunt current barrier (Appartus #2) forms a non-conductive flow channel which allows an electrolyte flow between neighboring electrochemical cells, but prevents ionic and electric conductivity, thereby canceling shunt currents between the electrochemical cells.

Unlike systems and methodologies of the art, and as depicted in FIG. 5, the inventors of the technology disclosed herein have developed a system that is configured such that an electrolyte is allowed to flow uninterruptedly through a bipolar connector (BPC) that is not a bipolar plate, positioned between any two electrochemical cells, or any two stacks of electrochemical cells, while maintaining a cell activity in terms of totally avoiding or minimizing leakage currents. In addition, the system allows for electric conductivity between the anode and cathode of neighboring electrochemical cells, thus ensuring electronic conductivity. This unconventional approach negates use of a conventional bipolar plate for forming a physical barrier between the cells for the purpose of preventing flow of electrolyte through it. In systems of the invention, such a physical barrier is not present and the electrolyte solution flow pathways remain open.

Thus, in a first aspect, the invention provides a bipolar system comprising two or more electrochemical cells, each connected to another via a serial electrical connection (in series connection), and a bipolar connector, BPC (operable as a shunt current suppression device) positioned in a flow path of an electrolyte solution flowing between the cells, said BPC being (positioned between each two of the two or more electrochemical cells and) configured to permit uninterrupted flow of the electrolyte solution and to prevent or reduce or diminish or minimize ionic shunt current from crossing said device; wherein said system is free of a bipolar plate or bipolar separator.

The invention further provides a system comprising a stacked arrangement of two or more electrochemical cells, each cell in said arrangement being connected in series to another cell in the arrangement through a BPC (operable as a shunt current suppression device) configured and operable to permit directional flow (along a flow path) of an electrolyte solution between cells in the stack and preventing ionic current leakage; wherein the system is in a bipolar arrangement absent of a bipolar plate or bipolar separator.

Further provided is a system comprising one or more bipolar stacks, each stack comprising two or more electrochemical cells, each containing an electrode assembly and an electrolyte solution; the cells in each stack being arranged in series and are fluidically associated via an intercell conduit defining a flow path of the electrolyte solution between (adjacent) cells; the conduit comprising (or provided with) a BPC (operable as a shunt current suppression device) configured and operable to reduce or prevent current leakage while maintaining flow of the electrolyte solution; wherein the system is provided in a bipolar arrangement and wherein each of the stacks is free of bipolar plates or bipolar separators.

Also provided is an electrochemical system comprising:
a plurality of electrochemical cells, e.g., E-TAC cells, arranged in a plurality of stacks, wherein each cell is connected in series to another cell in the stack;
means for supplying an electrolyte solution to the stack/cells as a shared electrolyte;
an electrolyte conduit configured as an electrolyte flow path, whereby the conduit is provided with a BPC configured and operable to reduce or prevent current leakage while maintaining (uninterrupted) flow of the electrolyte solution; wherein the system is provided in a bipolar arrangement and wherein each of the stacks is free of bipolar plates or bipolar separators.

The invention further provides an electrochemical system configured and operable for minimizing shunt currents in the system, e.g., an E-TAC system, the system comprising a plurality of stacks, each stack comprising a plurality of electrochemical cells connected in series, said system comprising an electrolyte solution shared by the plurality of cells, wherein a solution flow path is provided with a BPC (a shunt current suppression device) allowing an electrolyte to flow through the path and through the BPC to reduce (minimize or eliminate) ionic shunt currents as compared to a system absent of the BPC.

As disclosed herein, the electrolyte flows from an electrolyte storage tank through pipes to the stack (with or without pump and heating/cooling devices as required by the process), and through each of the cells in the stack and the bipolar connectors to the stack outlet. The electrolyte solution is then returned back to the electrolyte tank or to a gas/liquid separator, as may be the configuration of the system.

In systems of the invention, the electrolyte or aqueous solution is circulated through the cells and stacks and through any one or more shunt current suppression device, i.e., the BPC, that may be present in the electrolyte path and provided between any two of the cells and optionally any two of the stacks, as depicted in FIG. 5. Typically, the electrolyte solution is shared between cells within a given stack and between the stacks. Thus, a system of the invention may also be provided with one or more manifolds that permit circulation of the electrolyte solution to and within the system. The circulation is further enabled by presence of channels or conduits or other components, provided with the BPC or shunt current suppression device.

Systems of the invention, lacking bipolar plates or separators, are stacked arrangements in bipolar connectivity. In such arrangements, several single electrochemical cells may be assembled in series to form “a stack” of electrochemical cells. Several stacks may then be further assembled. As described for individual electrochemical cells, the stack is also arranged with positive and negative current collectors that cause electrons to flow through the cell stack along an axis normal to the ion transfer membranes and current collectors during electrochemical charge and discharge.

In some embodiments, the system or each of the stacks in the system or each electrochemical cell in stacks of the system is an electrochemical thermally activated chemical cell (E-TAC) electrolyzer [1,2]. As stated herein, in an E-TAC, the anode and cathode of a single stack are contained within a single compartment and the electrolyte flows between neighboring stacks. Therefore, a bipolar connector (BPC), on the one hand, provides an electrical ionic insulation between adjacent stacks, and on the other hand, provides passage of electrolyte and produced gas through the reactor.

According to another aspect the invention provides a system for generating hydrogen gas and/or oxygen gas, the system comprising at least one stack of two or more electrochemical thermally activated chemical cells (‘E-TAC cells’), each of the two or more cells being configured for holding an electrolyte solution and comprising an electrode assembly having a cathode electrode and an anode electrode, the two or more cells being configured to generate hydrogen gas in the presence of electrical bias and generate oxygen gas in the absence of bias;

wherein each of the two or more cell in said at least one stack being connected in series to another of the two or more cells in the stack via a BPC, i.e., an ionic current interrupter or a shunt current suppression device configured and operable to permit directional flow of the electrolyte solution between cells and preventing ionic current leakage; wherein the system is in a bipolar arrangement absent of a bipolar plate or bipolar separator.

In some embodiments, the system comprises a control unit configured to operate the two or more cells or stacks in accordance with an operational pattern.

A system, e.g., an E-TAC system, of the invention comprises multiple cells, e.g., a plurality thereof or at least two cells or two or more such cells, each being in the form of a compartment/container comprising at least one electrode assembly and configured for holding an aqueous/electrolyte solution. The number of cells in a system of the invention may vary based on, inter alia, the intended operation, operational patterns, etc. Each cell is configured to have a dual function such that during application of electric bias to the cell (bias ON) hydrogen gas may be generated and in the absence of an applied bias (bias OFF) spontaneous generation of oxygen gas may take place.

As detailed herein, each of the two or more cells comprises an electrode assembly that includes an anode and a cathode and thus can serve as a single independent unit, configured for generation of both hydrogen gas and oxygen gas. It should be noted that each of the two or more cells is not a half-cell comprising an electrode and an electrolyte.

The electrode assembly comprises a cathode that in the presence of bias generates hydrogen gas, optionally by reducing water, and further brings about generation of hydroxide ions. Generation of hydrogen gas may be under basic pH, acidic pH or natural pH. Thus, the water medium may be acidic, neutral or basic, may be selected from tap water, sea water, carbonate/bicarbonate buffers or solutions, electrolyte-rich waters, etc. In some embodiments, the cathode is configured to affect reduction of water molecules to generate hydrogen gas and optionally hydroxide ions. In some other embodiments, the cathode reduces hydrogen ions in an aqueous solution to generate hydrogen gas. The cathode may be of a material selected from a metal and electrode materials used in the field. The electrode material may, for example, be selected from nickel, Rancy nickel, copper, graphite, platinum, palladium, rhodium, cobalt. MoS2 and their compounds. In some embodiments, the electrode material is not cadmium (Cd) or does not comprise cadmium. In some embodiments, the cathode consists Raney nickel, copper, graphite or platinum.

While the anode may comprise or may consist identical electrode materials as the cathode, the material of the anode must permit at least one redox cycle (reaction), i.e., oxidation, reduction, in accordance with the invention. In other words, the anode in accordance with the invention is capable, under conditions described herein, of reversibly undergoing an oxidation step in the presence of applied bias (anode charging) and a subsequent reduction step in the absence of bias (anode regeneration), to generate oxygen gas. This may be optionally followed by a further redox cycle. The term “reversibly” or “reversibility”, when used in connection with the electrode, refers to the ability of the electrode to chemically undergo reduction/oxidation, without reversing the polarity of the system. The turning ON/OFF of bias does not constitute reversal of polarity as known in the art. Therefore, it may be said that the reversibility of the anode is inherent to the electrode material.

As the redox reaction must include proton exchange, the anode material must allow for a redox potential above 1.23V and below 1.8V, versus the hydrogen reversible electrode (RHE), as further disclosed herein. The bias voltage is measured at 25° C., as indicated below.

Thus, in accordance with some embodiments, a system comprises
at least one stack of two or more E-TAC cells, each of the cells being configured for holding an electrolyte solution and comprising at least one electrode assembly, each having a cathode electrode and an anode electrode, the cathode being configured to affect reduction of water in the electrolyte solution in response to an applied electrical bias, to thereby generate hydrogen gas and hydroxide ions, the anode being capable of reversibly undergoing oxidation in the presence of hydroxide ions, and undergoing reduction in the absence of bias, to generate oxygen gas,

wherein each of the two or more cells in said at least one stack is connected in series to another of the two or more cells in the stack via a BPC, i.e., an ionic current interrupter or a shunt current suppression device, configured and operable to permit directional flow of the electrolyte solution between adjacent cells and preventing ionic current leakage; wherein the system is in a bipolar arrangement absent of a bipolar plate or bipolar separator.

The invention further provides a method for minimizing ionic shunt currents in an electrochemical system, e.g., an E-TAC system, the system having a plurality of stacks, each stack comprising a plurality of cells connected in series, said system comprising an electrolyte solution shared by the plurality of cells, wherein a solution flow path is provided with a BPC, the method comprising flowing an electrolyte through the path provided with the BPC to at least partially reduce shunt currents as compared to a system absent of the BPC.

Also provided is a method for minimizing ionic shunt currents in an electrochemical system, the method comprising
providing a system having a plurality of stacks, each stack comprising a plurality of electrochemical cells connected in series, said system comprising an electrolyte solution shared by the plurality of cells, wherein a solution flow path between any two cells is provided with a bipolar connector (BPC), and
flowing an electrolyte solution through the path provided with the BPC to at least partially reduce shunt currents as compared to a system absent of the BPC.

The invention further provides a method for minimizing ionic shunt currents in an electrochemical system, the system having a plurality of stacks, each stack comprising a plurality of electrochemical cells connected in series, said system comprising an electrolyte solution shared by the plurality of cells, wherein a solution flow path between any two cells is provided with a bipolar connector (BPC), the method comprising flowing an electrolyte solution through the path provided with the BPC to at least partially reduce ionic shunt currents in the system.

A method is provided for minimizing ionic shunt currents in an electrochemical system, the method comprising
providing a system having a plurality of electrochemical cells connected in series, and an electrolyte solution flown between the plurality of cells through a conduit defining a solution flow path; and
assembling a bipolar connector (BPC) along the solution flow path provided between any two cells such that the electrolyte solution flows through the BPC, to thereby at least partially reduce ionic shunt currents in the system.

As explained herein, ionic currents are generated and driven by a cell-to-cell potential gradient of the stack. When each cell in a stack shares a common electrolyte wherein a low resistance path exists, a shunt current occurs. The “shunt current” refers to a situation whereby the current chooses a less resistive pathway to reach the end cell. As disclosed herein, the approach developed by the inventors to achieve an electrical ionic insulation while providing passage of electrolyte between the stacks involves positioning of a mechanical or physical bipolar connector (BPC) that is a shunt current suppression device or an ionic electrical insulator in a flow path of the electrolyte solution, wherein the structure or operation of the BPC permits uninterrupted flow of the electrolyte solution in the path and further prevents or reduces the ionic shunt current (current leakage).

The bipolar connector (BPC) is not a bipolar plate nor a bipolar separator as known in the art. As disclosed herein, and depicted in FIGS. 4 and 5, unlike a bipolar plate or a bipolar separator, a BPC used according to the invention permits substantially uninterrupted electrolyte flow through the cells/stacks, while permitting also electronic conductivity. As the BPC is structured to provide ionic insulation despite the continuous electrolyte flow.

The BPC, one or more, is provided a long the electrolyte flow path, separating any two electrochemical cells. BPCs may also be utilized to separate between stacks of electrochemical cells. In some embodiments, the BPC is provided between any two electrochemical cells in a stack at a position along the flow path of the electrolyte solution. In some embodiments, the BPC is provided between any two stacks at a position along the flow path of the electrolyte solution. In some embodiments, the BPC is provided between any two electrochemical cells in a stack and/or between any two stacks, at a position along the flow path of the electrolyte solution between the electrochemical cells or between the stacks.

Generally speaking, the BPC may be a continuous conduit defining an electrolyte path, which may be provided in a form (e.g., length, diameter or cross-section, structure, shape, inclusion of mechanical members, etc) that suppresses or reduced ionic shunt currents. Shunt current suppression or ionic electrical insulation may be achieved by a variety of BPC configurations. In some implementations, insertion of gas bubbles into the electrolyte solution reduces or breaks up the path of the electrolyte (exemplified in FIG. 7A and FIG. 10). Additionally or alternatively, the electrolyte path may be lengthened and reduced in cross-section such that the electrical resistance of the electrolyte along the path is increased (FIG. 7B, FIG. 8).

Shunt current suppression or ionic electrical insulation may also be achieved by introducing BPC with geometric structures or members along the electrolyte path.

Current leakage may also be prevented by utilizing a perforated plate having boreholes penetrating the plate, wherein the plate is configured to receive an electrolyte solution to an upper surface of the perforated plate to flow through the boreholes (FIGS. 9A-B and FIG. 10). Gas bubbles that form during the charging step or during gas production, e.g., hydrogen gas production, flow through the boreholes and create electrolyte separation/gap between the two areas separated by the bipolar connector thus blocking the ionic path.

To minimize a pressure drop at the BPC, the mechanical resistance in the electrolyte flow path should be reduced. To achieve this, the device may include welds or joiners or structural deformations that are designed to minimize mechanical resistance in the electrolyte flow path.

In some embodiments, the shunt currents are reduced by increasing electrical resistance in the electrolyte pathways, for example by proving a BPC with increasing length of the fluid path, by arranging the path into a loop pattern, by introducing a moving gap or by introducing a resistive electrolyte connection, as further disclosed herein.

In some embodiments, the BPC may be in a form of a moving gap (a physical disconnection) and/or a highly resistive electrolyte connection that is introduced into the electrolyte path. A moving gap in the electrolyte can be achieved by an isolating solid, liquid or gas. FIGS. 6 and 7 show two exemplary implementations utilizing a moving gap approach using an isolating solid (FIG. 6) or an isolating gas or liquid pocket (FIG. 7A).

FIG. 6 shows an approach whereby the BPC is in a form of a solid revolving barrier. In this approach, the revolving barrier separates between the “in” and “out” of the flow, such that the bottom part of the barrier (a first cell/stack) is always separated ionically and physically from the upper part of the barrier (a further cell/stack).

Similarly. FIG. 7A shows an electrolyte flow through a BPC in a form of a pocket of an isolating gas or liquid which breaks the connection between the top and bottom electrolyte. Such a gas pocket, for example, can be formed by moving a two-phase flow (gas and liquid) in a spiral channel as illustrated in FIG. 7B. The spiral flow leads to separation of liquid and gas (by the centrifugal forces and different density) and the formation of a gas pocket that breaks the connection between the top and bottom electrolyte.

The BPC implemented in systems of the invention may be an electrolyte path shaped as a loop. The loop may be a helical loop as shown in FIG. 7B, or may be configured to adopt other shapes, such as elliptical, rectangular with straight ends or rounded ends, or in any other shape. A highly resistive electrolyte BPC or connection can be achieved by forming channels within the electrolyte pathway. A simple example of such a design is shown as FIG. 8. In some embodiments, the channel is long and narrow, thereby effectively increasing the BPC resistance according to the equation

$${R}_{ch} = \frac{4 {l}_{ch}}{π {d}_{ch}^{2}} \frac{1}{{σ}_{el}} .$$

In some embodiments, the BPC is a resistive electrolyte connection. In an electrolyzer, the electrolyte contains gas bubbles which are significantly more resistive than the electrolyte. These gas bubbles increase the effective resistance of the electrolyte and improve the BPC performance. A practical BPC design based on the resistive electrolyte connection is presented in FIG. 9A showing a side view (left) and a front view (right) of the BPC.

The BPC shown on FIG. 9B is provided with several channels (the dimensions of channels designated next to the Figure) with conical inlet and outlet. Geometric dimensions of the channels determine the BPC pressure drop, the ionic electrical resistance and the geometric dimensions of the metallic tab determines the electrical resistance:
1) Pressure drop (Δp)—depends on diameter of channel (d_{ch}), length of channel (l_{ch}), number of channels (N_{ch}) and the flow rate of electrolyte through BPC; and
2) Ionic electrical resistance (Rᵢₒₙ)—depends on diameter of channel (d_{ch}), length of channel (l_{ch}), number of channels (N_{ch}) and the ratio of gas flow rate to liquid electrolyte flow rate.
3) Electrical resistance (R_{elc})—depends on the tab length (l), width (w) and thickness (t).

These values may be expressed with geometric dimensions of the channel, number of channels, parameters of two-phase flow (electrolyte+gas hydrogen) and electrical parameters of the electrolyte:

$$Δ p = \frac{1}{{N}_{ch}} λ \frac{{l}_{ch}}{{d}_{ch}} \frac{ρ}{2} {V}_{el}^{2} \qquad ( 1 )$$

$${R}_{ion} = \frac{1}{{N}_{ch}} \frac{4 {l}_{ch}}{π {d}_{ch}^{2}} ( \frac{1}{{σ}_{el}} + f ( \frac{{G}_{gas}}{{G}_{el}} ) ) , \qquad ( 2 )$$

$${R}_{elc} = {ρ}_{e} \frac{1}{wt} \qquad ( 3 )$$

wherein
λ—coefficient of friction in the channel;
ρ—density of electrolyte;
Vₑₗ—velocity of electrolyte;
σₑₗ—conductivity of electrolyte;
ρₑ—conductor resistance

$$\frac{{G}_{gas}}{{G}_{el}}$$

—ratio of mass flux of gas to mass flux of electrolyte; and

$$f ( \frac{{G}_{gas}}{{G}_{el}} )$$

—a non-linear function expressing the dependence of the additional channel resistance caused by presence of a non-conductive gas (H₂) in a two-phase flow (KOH/H₂) on mass flux ratio.

In such a design, an increase in the device resistance (Rᵢₒₙ) and a decrease in a pressure drop (Δp) are desired. However, as can be seen from equations (1) and (2), increasing the ohmic resistance of channels is always accompanied by an increase in the pressure drop. The second member in equation (2) is not depended on the geometrical dimensions of the channel (in contrast to the ohmic component of the resistance

$$\frac{4 {l}_{ch}}{{σ}_{el} π {d}_{ch}^{2}}$$

and pressure drop). Thus, it is possible to achieve a significant increase in the resistance by increasing of the ratio

$$\frac{{G}_{gas}}{{G}_{el}} .$$

A combined design may also be utilized as a device in E-TAC systems disclosed herein. An exemplary design which combines both a moving gap in the electrolyte pathway (physical disconnection) and highly resistive electrolyte connection within the BPC is shown in FIG. 10. In the gas accumulator design presented in FIG. 10, a complex channel structure is implemented which includes a void which leads to gas accumulation in the void and formation of gas pockets. These gas pockets continue to move in the channel while generating an electrolyte gap.

Independent on the type of BPC type it must be located along the fluid electrolyte path. It should be appreciated that the BPC may be positioned anywhere along the path to increase conduit length and reduce shunt currents.

### BRIEF DESCRIPTION OF THE DRAWINGS

In order to better understand the subject matter that is disclosed herein and to exemplify how it may be carried out in practice, embodiments will now be described, by way of non-limiting example only, with reference to the accompanying drawings, in which:

FIG. 1 illustrates a monopolar configuration according to the state of the art.

FIG. 2 illustrates a bipolar configuration according to the state of the art.

FIG. 3 demonstrates current leakage between adjacent cells.

FIG. 4 demonstrates a bipolar concept of operation according to the state of the art.

FIG. 5 demonstrates a bipolar connector (BPC) concept of operation according to the invention.

FIG. 6 provides an example of a moving gap design in a form of a rotating solid barrier.

FIGS. 7A-B provide examples of a moving gap design (FIG. 7A) by an isolating pocket and a loop design (FIG. 7B).

FIG. 8 provides an example of a resistive electrolyte connection design.

FIGS. 9A-B show a side and a front view of a BPC design combining both a moving gap and a resistive connection. (FIG. 9A) shows the full device and its electrical connections to the roll (side and front) and (FIG. 9B) shows the channels structure.

FIG. 10 shows a gas accumulator BPC according to some embodiments of the invention.

FIG. 11 provides a structure of bipolar rolls assembly configuration according to some embodiments of the present invention.

FIG. 12 presents an IV curve of an E-TAC reactor measured during LSV test between 1.5-3.5V.

FIG. 13 shows a voltage measurement in an E-TAC demonstration system in two configurations: mono-polar (Cell 1—MP) and bi-polar (Cell 1—BP).

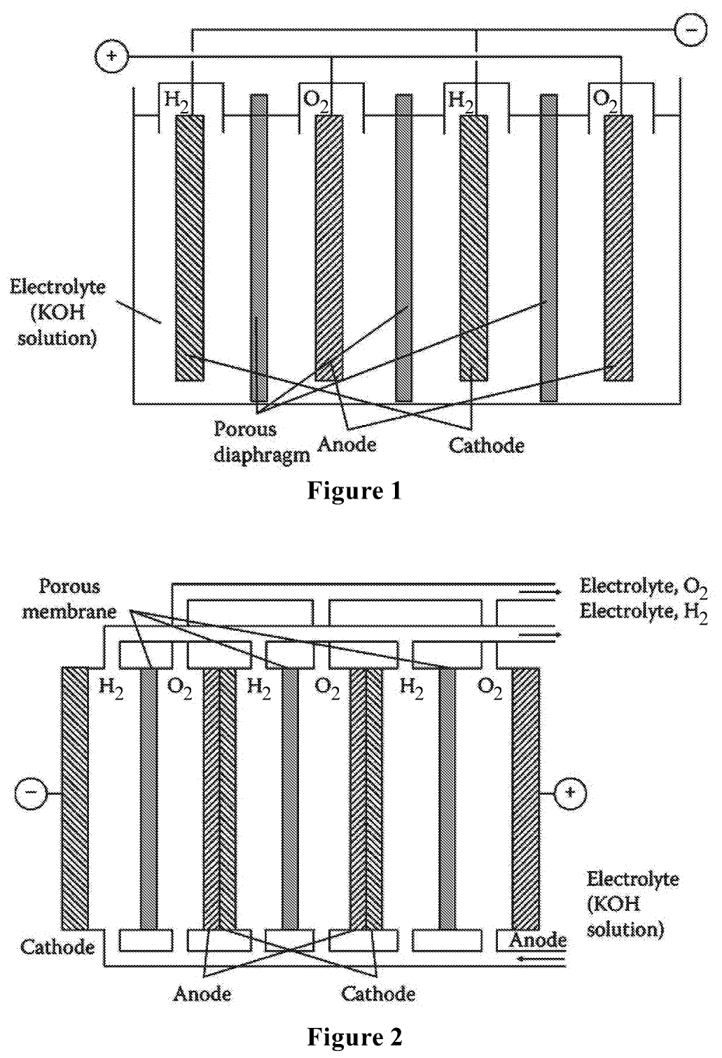

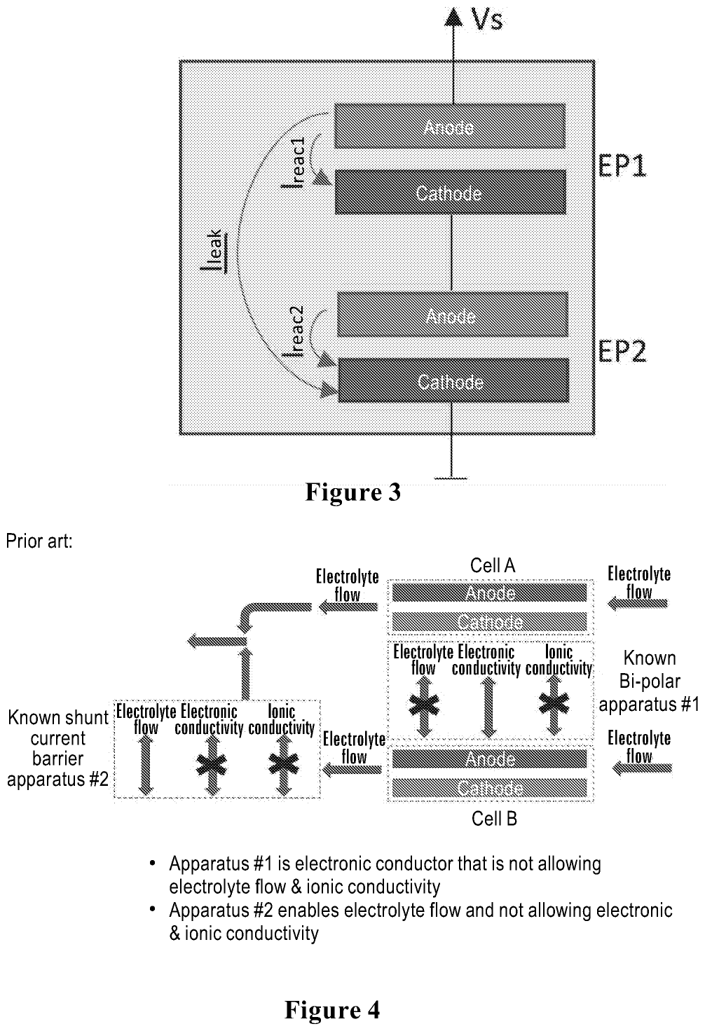

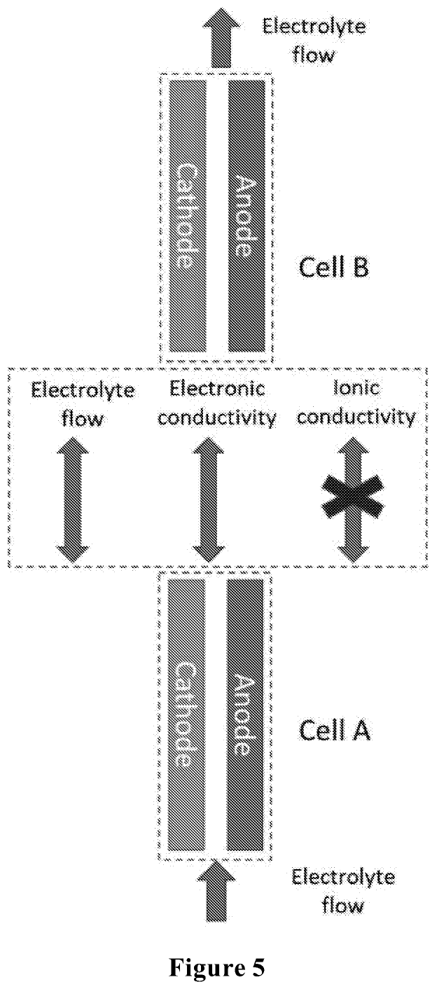

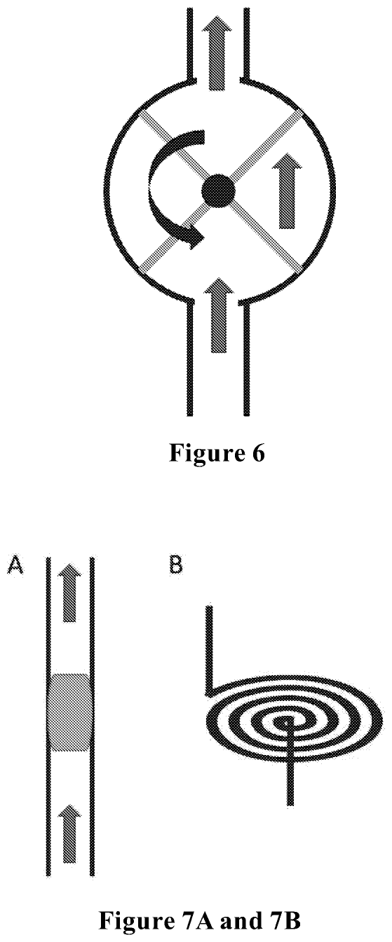

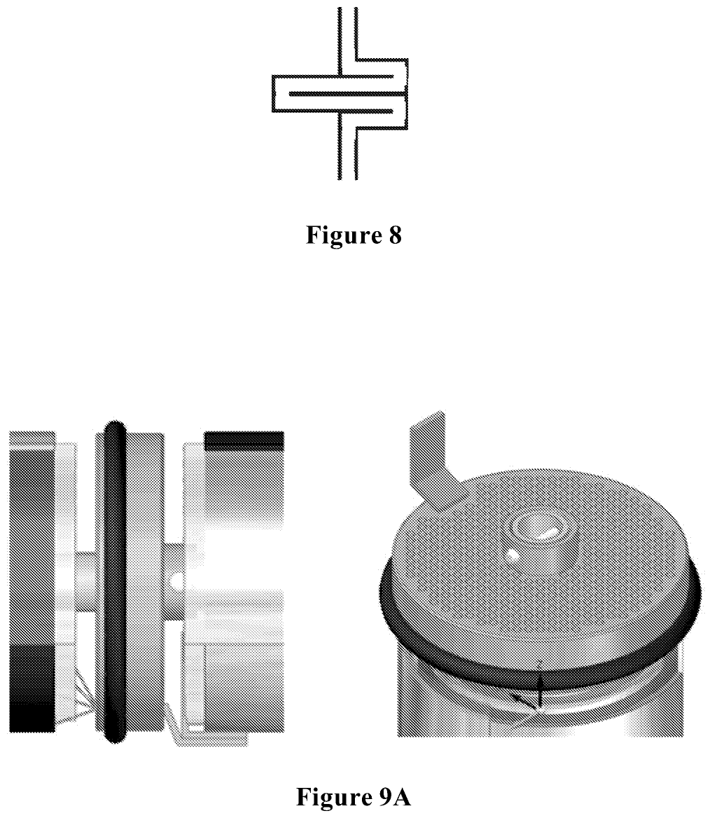

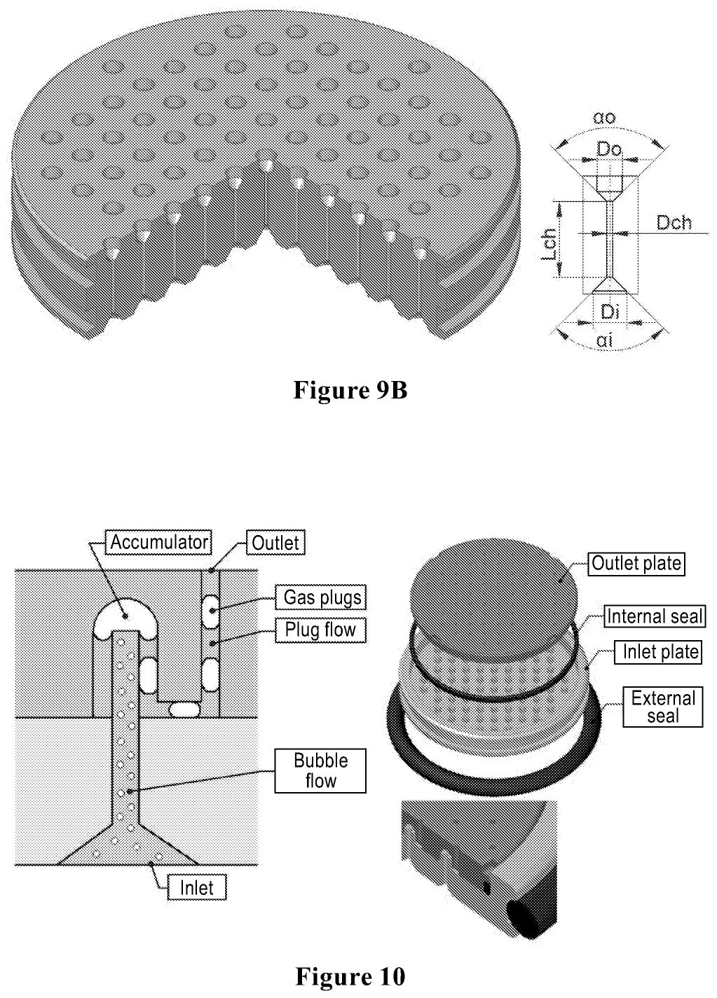

### DETAILED DESCRIPTION OF EMBODIMENTS

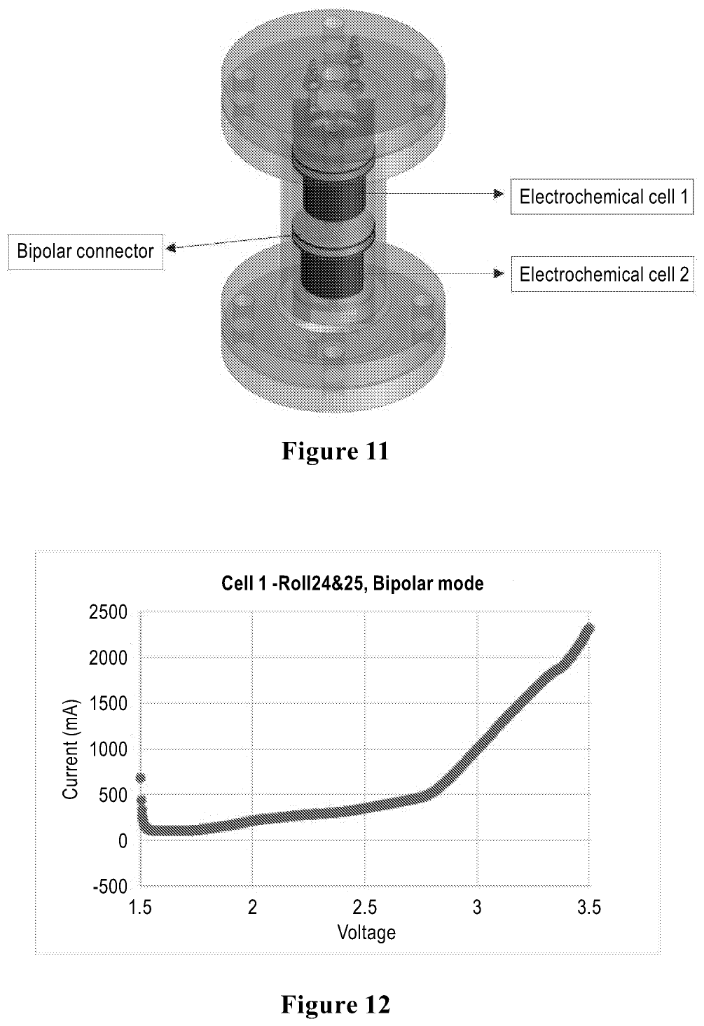

Two rolls, each defining an electrochemical cell (electrochemical cell 1 and 2), were assembled in an E-TAC reactor as presented in FIG. 11. Between the two cells there was provided a BPC such as that presented in FIG. 10. The reactor was tested in an E-TAC demonstration system with a 5M KOH electrolyte. The electrochemical measurements were performed using a 10A, 4V Ivium potentiostat channels.

### Example 1

In the first experiment, linear scan voltammetry (LSV) was used to characterize the onset potentials for bipolar electrodes operation, shown ion FIG. 12.

As can be seen, below 2.7V the potential was too low for 2 rolls in series connection. At this voltage the low current measured was a small leak current between the anode of the first roll and the cathode of the second roll. However, as the voltage increased above 2.7V the current increased significantly. At this voltage there was enough voltage for each roll to operate (>1.35V) and the current measured was mainly due to current that flowed through the BPC connecting the two rolls, as explained before. This showed that the BPC was able to fulfil its goal of reducing the leak current significantly.

### Example 2

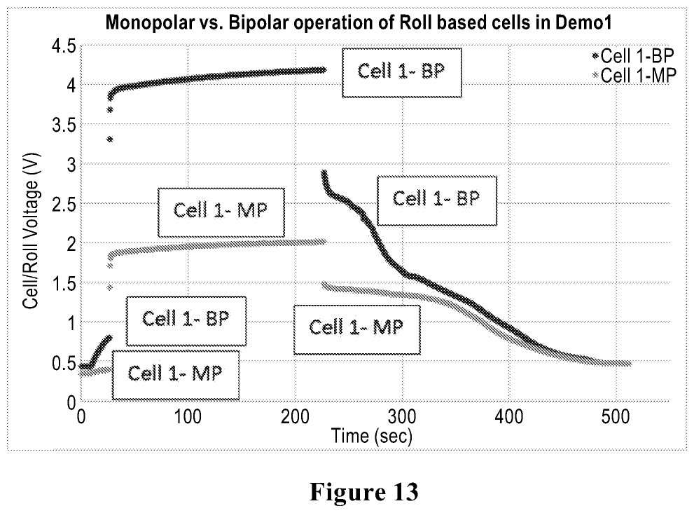

Same experimental setup was used to investigate the operation in a full E-TAC cycle. In this experiment the same two rolls were used in two different configurations: a monopolar configuration and a bipolar configuration. In both configurations the current flow through each roll was expected to be 5 A and therefore the same hydrogen production was expected. FIG. 13 presents the measured voltage of the reactor at the two configurations. Table 1 shows the average voltage and power consumed in each configuration.

TABLE 1
comparison between cells in monopolar and bipolar configurations

| | Maximum | Average | | AVG power | Hydrogen |
|---|---|---|---|---|---|
| | voltage | voltage | I | consumed | production rate |
| | (V) | (V) | [A] | (W) | (g/day) |
| Cell 1-MP | 2.010 | 1.957 | 10 | 19.6 | 8.95 |
| Cell 1 - BP | 3.981 | 3.883 | 5 | 19.4 | 8.95 |

Table 1 clearly shows that adding the BPC between the two rolls forms a bi-polar configuration, thereby reducing the current (by a factor of two) while doubling the voltage. This configuration reduces the consumed power compared to the monopolar configuration.

1-23. (canceled)

24. A system comprising one or more bipolar stacks, each stack comprising two or more electrochemical cells, each containing an electrode assembly and an electrolyte solution; the cells in each stack being arranged in series and are fluidically associated through an intercell conduit defining a flow path of the solution between the cells; the conduit comprising a bipolar connector (BPC) configured and operable to reduce or prevent current leakage while maintaining flow of the electrolyte solution; wherein the system is provided in a bipolar arrangement and wherein each of the stacks is free of bipolar plates or bipolar separators.

25. An electrochemical system comprising:
a plurality of electrochemical cells arranged in a plurality of stacks, wherein each cell is connected in series to another cell in the stack;
means for supplying an electrolyte solution to the cells/stack as a shared electrolyte;
an electrolyte conduit configured as an electrolyte flow path, whereby the conduit is provided with a bipolar connector (BPC) configured and operable to reduce or prevent current leakage while maintaining flow of the electrolyte solution;
wherein the system is provided in a bipolar arrangement and wherein each of the stacks is free of bipolar plates or bipolar separators.

26. The system according to claim 24, wherein the two or more electrochemical cells are stacked in bipolar connectivity.

27. The system according to claim 24, provided with one or more manifolds permitting circulation of the electrolyte solution to and within the system.

28. The system according to claim 24 being an electrochemical thermally activated chemical cell (E-TAC) electrolyzer.

29. The system according to claim 28, the system comprises a control unit configured to operate the two or more stacks in accordance with an operational pattern.

30. The system according to claim 28, comprising
at least one stack of two or more E-TAC cells, each of the cells being configured for holding an electrolyte solution and comprising at least one electrode assembly, each having a cathode electrode and an anode electrode, the cathode being configured to affect reduction of water in the electrolyte solution in response to an applied electrical bias, to thereby generate hydrogen gas and hydroxide ions, the anode being capable of reversibly undergoing oxidation in the presence of hydroxide ions, and undergoing reduction in the absence of bias, to generate oxygen gas,
wherein each of the two or more cells in said at least one stack is connected in series to another of the two or more cells in the stack via a bipolar connector (BPC) configured and operable to permit directional flow of the electrolyte solution between adjacent cells and preventing ionic current leakage; wherein the system is in a bipolar arrangement absent of a bipolar plate or bipolar separator.

31. The system according to claim 24, wherein the BPC is a continuous conduit defining the electrolyte path, wherein the conduit comprises welds or joiners selected to minimize mechanical resistance in the path.

32. The system according to claim 24, wherein the BPC is a continuous conduit defining the electrolyte path, wherein the conduit comprises a moving gap or a resistive electrolyte connection.

33. The system according to claim 32, wherein the moving gap is an isolating solid, liquid or gas.

34. The system according to claim 32, wherein the moving gap is a gas bubble or a plurality thereof.

35. The system according to claim 24, wherein the BPC is a solid revolving barrier.

36. The system according to claim 24, wherein the BPC is a continuous conduit defining the electrolyte path, wherein the conduit is arranged as a loop.

37. The system according to claim 36, wherein the loop is a helical loop.

38. The system according to claim 24, wherein the BPC is a resistive electrolyte connection.

39. The system according to claim 24, wherein the BPC comprises a perforated plate having boreholes penetrating the plate, wherein the plate is configured to receive the electrolyte solution to an upper surface of the perforated plate to flow through the boreholes.

40. A method for minimizing ionic shunt currents in an electrochemical system, the method comprising
providing a system having a plurality of stacks, each stack comprising a plurality of cells connected in series, said system comprising an electrolyte solution shared by the plurality of cells, wherein a solution flow path between any two cells is provided with a bipolar connector (BPC), and
flowing an electrolyte solution through the path provided with the BPC to at least partially reduce shunt currents as compared to a system absent of the BPC.

41. A method for minimizing ionic shunt currents in an electrochemical system, the system having a plurality of stacks, each stack comprising a plurality of cells connected in series, said system comprising an electrolyte solution shared by the plurality of cells, wherein a solution flow path between any two cells is provided with a bipolar connector (BPC), the method comprising flowing an electrolyte solution through the path provided with the BPC to at least partially reduce ionic shunt currents in the system.

42. The method according to claim 40, wherein the system is E-TAC.

43. The method according to claim 42, wherein the system comprises a plurality of stacks, each stack comprises two or more electrochemical cells.
